(19) United States
(12) Patent Application Publication
(10) Pub. No.: US 2010/0054285 A1
(43) Pub. Date: Mar. 4, 2010

(54) All Fiber Mode Locked Fiber Laser at One Micron

(76) Inventor: Jian Liu, Sunnyvale, CA (US)

Correspondence Address: JOHN MARTIN TABOADA, 1923 N. NEW BRAUNFELS, SAN ANTONIO, TX, 78208, US

(21) Appl. No.: 12/548,258

(22) Filed: Aug. 26, 2009

Related U.S. Application Data
(60) Provisional application No. 61/190,266, filed on Aug. 27, 2008.

(51) Int. Cl. H01S 3/30; H01S 3/098; H01S 3/083

(52) U.S. Cl. 372/6; 372/18; 372/94

(57) ABSTRACT

Methods and systems for generating mode locked, femtosecond and picosecond laser pulses are disclosed, including generating electromagnetic radiation from a pump laser; coupling the pump laser electromagnetic radiation to a ring cavity comprising: a WDM coupler, a Ytterbium doped fiber, a first single mode fiber, a bandpass filter and dispersion device; a second single mode fiber; a first in-line polarization controller; an in-line polarization beam splitter comprising a polarization maintaining output configured to emit the laser pulses out of the ring cavity and a single mode fiber output coupled back into the ring cavity; a polarization insensitive isolator; a second in-line polarization controller; and a third single mode fiber; and wherein the ring cavity is configured to operate at net anomalous dispersion. Other embodiments are described and claimed.

### I. CROSS REFERENCE TO RELATED APPLICATIONS

The inventor claims priority to provisional patent application No. 61/190,266 filed on Aug. 27, 2008.

### II. BACKGROUND

The invention relates generally to the field of all fiber, mode locked fiber lasers at one micron.

### III. SUMMARY

In one respect, disclosed is an all fiber, mode locked fiber laser comprising: a pump laser; and a ring cavity comprising: a WDM coupler comprising an input and an output, wherein the pump laser is coupled to the input of the WDM coupler; a Ytterbium doped fiber comprising an input and an output, wherein the input of the Ytterbium doped fiber is coupled to the output of the WDM coupler; a first single mode fiber comprising an input and an output, wherein the input of the first single mode fiber is coupled to the output of the Ytterbium doped fiber; a bandpass filter and dispersion device comprising an input and an output, wherein the input of the bandpass filter and dispersion device is coupled to the output of the first single mode fiber; a second single mode fiber comprising an input and an output, wherein the input of the second single mode fiber is coupled to the output of the bandpass filter and dispersion device; a first in-line polarization controller comprising an input and an output, wherein the input of the first in-line polarization controller is coupled to the output of the second single mode fiber; an in-line polarization beam splitter comprising an input, a polarization maintaining output configured to emit a laser pulse out of the ring cavity, and a single mode fiber output, wherein the input of the in-line polarization beam splitter is coupled to the output of the first in-line polarization controller; a polarization insensitive isolator comprising an input and an output, wherein the input of the polarization insensitive isolator is coupled to the single mode fiber output of the in-line polarization beam splitter; a second in-line polarization controller comprising an input and an output, wherein the input of the second in-line polarization controller is coupled to the output of the polarization insensitive isolator; a third single mode fiber comprising an input and an output, wherein the input of the third single mode fiber is coupled to the output of the second in-line polarization controller and the output of the third single mode fiber is coupled to the input of the WDM coupler; and wherein the ring cavity is configured to operate at net anomalous dispersion.

In another respect, disclosed is a method for generating mode locked femtosecond and picosecond laser pulses, the method comprising: generating electromagnetic radiation from a pump laser; and coupling the pump laser electromagnetic radiation to a ring cavity comprising: a WDM coupler comprising an input and an output, wherein the pump laser is coupled to the input of the WDM coupler; a Ytterbium doped fiber comprising an input and an output, wherein the input of the Ytterbium doped fiber is coupled to the output of the WDM coupler; a first single mode fiber comprising an input and an output, wherein the input of the first single mode fiber is coupled to the output of the Ytterbium doped fiber; a bandpass filter and dispersion device comprising an input and an output, wherein the input of the bandpass filter and dispersion device is coupled to the output of the first single mode fiber; a second single mode fiber comprising an input and an output, wherein the input of the second single mode fiber is coupled to the output of the bandpass filter and dispersion device; a first in-line polarization controller comprising an input and an output, wherein the input of the first in-line polarization controller is coupled to the output of the second single mode fiber; an in-line polarization beam splitter comprising an input, a polarization maintaining output configured to emit the laser pulses out of the ring cavity, and a single mode fiber output, wherein the input of the in-line polarization beam splitter is coupled to the output of the first in-line polarization controller; a polarization insensitive isolator comprising an input and an output, wherein the input of the polarization insensitive isolator is coupled to the single mode fiber output of the in-line polarization beam splitter; a second in-line polarization controller comprising an input and an output, wherein the input of the second in-line polarization controller is coupled to the output of the polarization insensitive isolator; a third single mode fiber comprising an input and an output, wherein the input of the third single mode fiber is coupled to the output of the second in-line polarization controller and the output of the third single mode fiber is coupled to the input of the WDM coupler; and wherein the ring cavity is configured to operate at net anomalous dispersion.

Numerous additional embodiments are also possible.

### IV. BRIEF DESCRIPTION OF THE DRAWINGS

Other objects and advantages of the invention may become apparent upon reading the detailed description and upon reference to the accompanying drawings.

FIG. 1 is a block diagram illustrating a nonlinear polarization, pulse shaping and spectral shaping, all fiber, mode locked fiber laser at one micron, in accordance with some embodiments.

FIG. 2 is a schematic showing the details of the polarization beam splitter using a polarization cube, in accordance with some embodiments.

FIG. 3 is a schematic showing the details of the polarization beam splitter using a birefringence crystal, in accordance with some embodiments.

FIG. 4 is a schematic showing the details of the dispersion device using a fiber Bragg chirped grating, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### V. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

In some embodiments, an all fiber, mode locked laser can generate mode locked femtosecond (fs) and picosecond (ps) pulses by utilizing components for polarization and spectral shaping. By varying the fiber cavity length, the repetition rate can vary from 100 MHz to 50 kHz. The pulse width can be adjusted from 50 femtoseconds to 1 nanosecond (ns) by adjusting the position of the output coupler and the fiber length in the cavity. In this embodiment, the entire cavity is designed to operate with a net anomalous dispersion (β″<0).

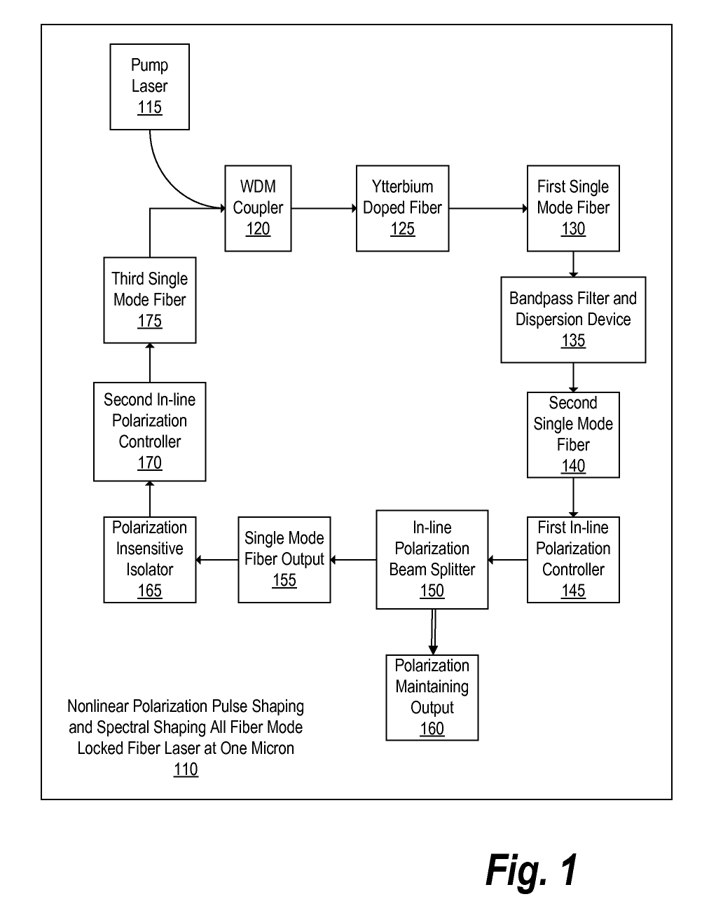

FIG. 1 is a block diagram illustrating a nonlinear polarization, pulse shaping and spectral shaping, all fiber, mode locked fiber laser at one micron, in accordance with some embodiments.

In some embodiments, a nonlinear polarization, pulse shaping and spectral shaping, all fiber, mode locked fiber laser at one micron, as shown in block 110, comprises a ring cavity laser comprising a pump laser 115 coupled with a WDM coupler 120. The pump laser 115 may be a 980 nm diode laser and the WDM coupler 120 may be either a 980/1060 or a 980/1030 coupler. The WDM coupler 120 couples the laser pulses from the pump laser 115 into the gain medium of Ytterbium doped fiber 125, having a high doping concentration ranging between 10,000 ppm to 2,000,000 ppm, to amplify the laser pulses. The amplified laser pulses from the Ytterbium doped fiber 125 output are coupled into a first single mode fiber 130, such as HI 1060 fiber or SM 25. The output of the first single mode fiber 130 is coupled into a bandpass filter and dispersion device 135 to achieve net anomalous dispersion in the ring cavity. The bandpass filter and dispersion device 135 has a bandwidth between 1 nm to 20 nm and may comprise a bandpass filter and a volume chirped grating, a bandpass filter and a photonic crystal fiber, a bandpass filter and a photonic bandgap fiber, or a fiber Bragg chirped grating. If a fiber Bragg chirped grating is used, it will not only serve as the dispersion device, but also the bandpass filter. The bandpass filter and dispersion device 135 is then coupled to a second single mode fiber 140, such as HI 1060 fiber or SM 25, that is then coupled to a first fiber based, in-line polarization controller 145. The output of the first in-line polarization controller 145 is then coupled with an in-line polarization beam splitter 150 having a single mode fiber output 155 and a polarization maintaining output 160. When the laser pulse passes through the in-line polarization beam splitter 150, only the highest intensity that is aligned with the in-line polarization beam splitter 150 will pass and the lower intensity part of the laser pulse will be filtered, thereby shaping the laser pulse and working like a saturable absorber to induce mode locking. The in-line polarization beam splitter 150 may either split the laser beam using a polarization splitter cube or a birefringence crystal. In both cases, the laser beam is split into a non-polarization maintaining single mode fiber 155 that is coupled back into the ring of the cavity to insure a stable mode-locking mechanism and a polarization maintaining fiber output 160. The single mode fiber output 155 is then coupled to a polarization insensitive isolator 165. The polarization insensitive isolator 165 is used in the ring cavity to insure unidirectional propagation. A second fiber based, in-line polarization controller 170 is then connected to the polarization insensitive isolator 165. The output of the second in-line polarization controller 170 is then coupled into a third single mode fiber 175, such as HI 1060 fiber or SM 25. The output of the third single mode fiber 175 is then coupled back into the WDM coupler 120, thus completing the all fiber ring cavity. The output power levels can be changed by adjusting the two in-line polarization controllers 145 and 170 and the in-line polarization beam splitter 150.

The just described all fiber mode locked fiber laser at one micron is polarized, self start, and operates at net anomalous dispersion (β″<0) to achieve stable mode locking pulses with a pulse repetition rate between 50 kHz to 100 MHz. The mode locking mechanism is created by both polarization shaping, due to the self phase modulation induced polarization change, and spectral shaping resulting from the bandwidth of the bandpass filter. By adjusting the position and lengths of the three single mode fiber segments, the chirped output width can vary from 1 to 30,000 times the de-chirped pulse width of 100 fs. The output pulse width can be chirped from 100 fs to 3 ns and the chirped output pulses can be de-chirped from 10 fs to 10 ps. The total fiber length in the cavity can range from 1 m to 3000 m. The output spectrum bandwidth of the all fiber, mode locked fiber laser ranges from 0.5 nm to 30 nm and has a center lasing wavelength between 1025 nm to 1100 nm.

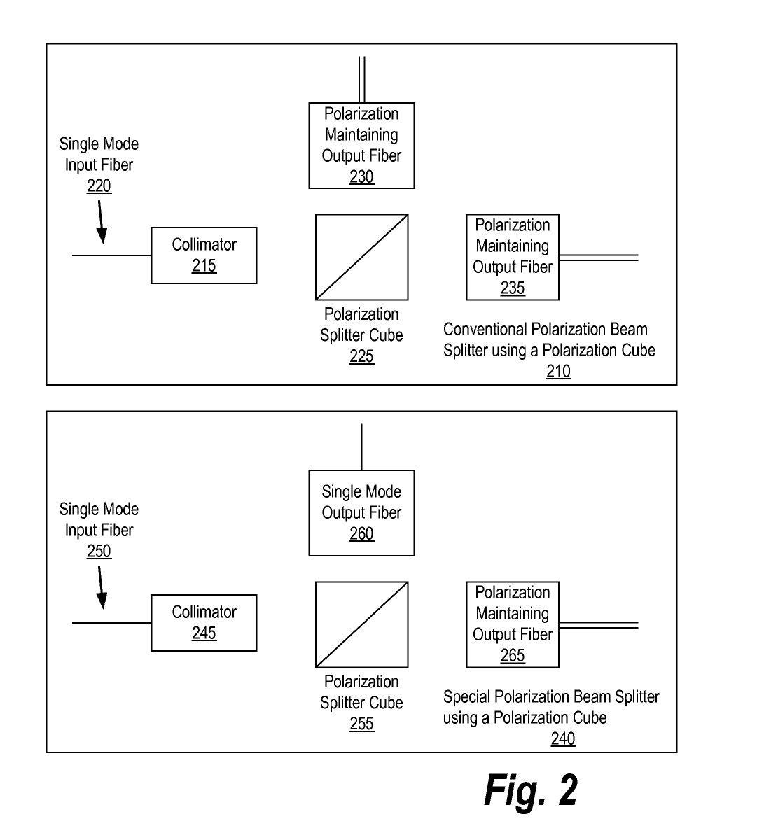

FIG. 2 is a schematic showing the details of the polarization beam splitter using a polarization cube, in accordance with some embodiments.

In some embodiments, the polarization beam splitter is of a special design. In conventional polarization beam splitters 210, the collimator 215 from the input fiber 220 hits a polarization splitter cube 225 and then splits the beam into two polarization maintaining output fibers, 230 and 235. In the special design for the polarization beam splitter 240, the collimator 245 from the input fiber 250 hits a polarization splitter cube 255 and then splits the beam into one single mode fiber 260 and a polarization maintaining fiber 265. The single mode fiber output 260 is coupled back into the ring cavity of the fiber laser. This insures a stable mode locking mechanism. The laser pulses exit the ring cavity through the polarization maintaining output fiber 265.

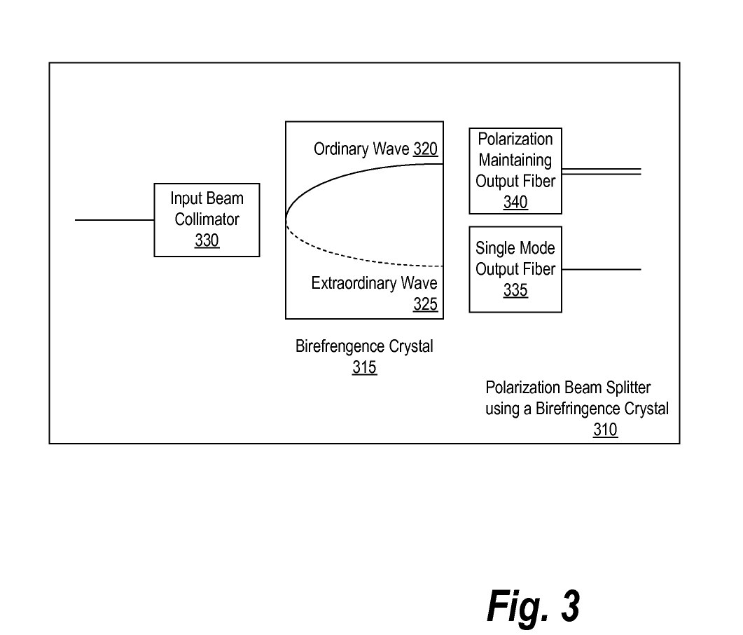

FIG. 3 is a schematic showing the details of the polarization beam splitter using a birefringence crystal, in accordance with some embodiments.

In some embodiments, polarization beam splitter 310 uses the double refraction of a birefringence crystal 315 to generate an ordinary wave 320 and an extraordinary wave 325 from a single collimated input beam 330. The split beams are coupled into two output fibers, one single mode fiber 335 and the other polarization maintaining fiber 340.

As in the output fibers from the polarization beam splitter using a polarization cube, the single mode fiber 335 is coupled into the ring cavity and the polarization maintaining fiber 340 is used as the polarized laser output.

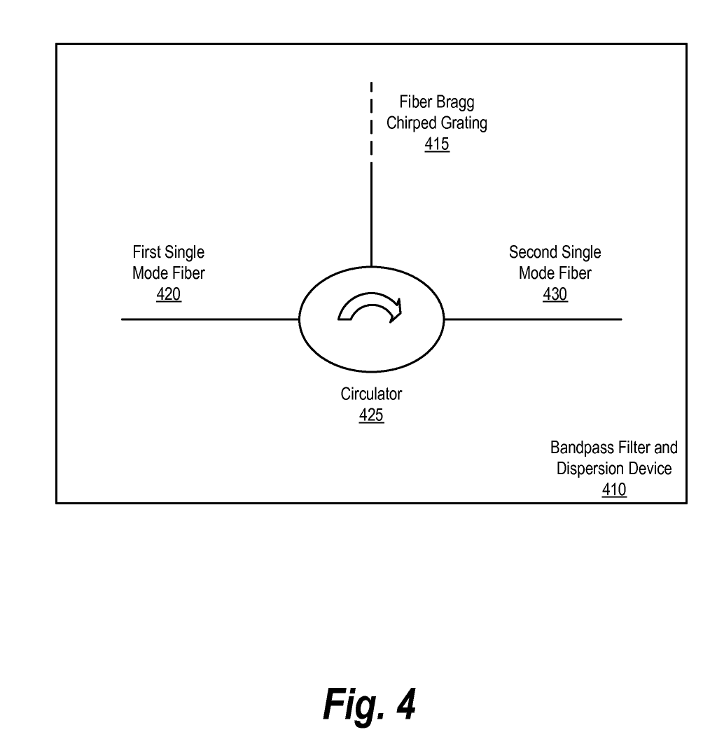

FIG. 4 is a schematic showing the details of the dispersion device using a fiber Bragg chirped grating, in accordance with some embodiments.

In some embodiments, the bandpass filter and dispersion device 410 comprises a fiber Bragg chirped grating 415. The first single mode fiber 420 is coupled into a circulator 425 that transmits the incoming laser pulses into the fiber Bragg chirped grating 415.

The laser pulses are then transmitted from the fiber Bragg chirped grating 415, through the circulator 425, and to the second single mode fiber 430. When a fiber chirped grating 415 is used in the ring cavity of the fiber laser, the fiber chirped grating 415 functions as both the dispersion device as well as the bandwidth filter. On the other hand, if another device, such as a volume chirped grating, a photonic crystal fiber, or a photonic bandgap fiber, is used to add anomalous dispersion to the ring cavity, then another bandwidth filter, such as a bandpass filter, would have to be added to the ring cavity of the fiber laser to assist in stabilizing the mode locking by spectral shaping.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. An all fiber, mode locked fiber laser comprising:
a pump laser; and
a ring cavity comprising:
a WDM coupler comprising an input and an output, wherein the pump laser is coupled to the input of the WDM coupler;
a Ytterbium doped fiber comprising an input and an output, wherein the input of the Ytterbium doped fiber is coupled to the output of the WDM coupler;
a first single mode fiber comprising an input and an output, wherein the input of the first single mode fiber is coupled to the output of the Ytterbium doped fiber;
a bandpass filter and dispersion device comprising an input and an output, wherein the input of the bandpass filter and dispersion device is coupled to the output of the first single mode fiber;
a second single mode fiber comprising an input and an output, wherein the input of the second single mode fiber is coupled to the output of the bandpass filter and dispersion device;
a first in-line polarization controller comprising an input and an output, wherein the input of the first in-line polarization controller is coupled to the output of the second single mode fiber;
an in-line polarization beam splitter comprising an input, a polarization maintaining output configured to emit a laser pulse out of the ring cavity, and a single mode fiber output, wherein the input of the in-line polarization beam splitter is coupled to the output of the first in-line polarization controller;
a polarization insensitive isolator comprising an input and an output, wherein the input of the polarization insensitive isolator is coupled to the single mode fiber output of the in-line polarization beam splitter;
a second in-line polarization controller comprising an input and an output, wherein the input of the second in-line polarization controller is coupled to the output of the polarization insensitive isolator;
a third single mode fiber comprising an input and an output, wherein the input of the third single mode fiber is coupled to the output of the second in-line polarization controller and the output of the third single mode fiber is coupled to the input of the WDM coupler; and
wherein the ring cavity is configured to operate at net anomalous dispersion.

2. The all fiber, mode locked fiber laser of claim 1, wherein the laser pulse has a center lasing wavelength ranging from 1025 nm to 1100 nm.

3. The all fiber, mode locked fiber laser of claim 1, wherein the laser pulse has a pulse repetition rate ranging from 50 kHz to 100 MHz.

4. The all fiber, mode locked fiber laser of claim 1, wherein the laser pulse has a spectrum bandwidth ranging from 0.5 nm to 30 nm.

5. The all fiber, mode locked fiber laser of claim 1, wherein the laser chirped pulse has a pulse width ranging from 100 fs to 3 ns and the chirped output pulses can be de-chirped from 10 fs to 10 ps.

6. The all fiber, mode locked fiber laser of claim 1, wherein the total length of the first single mode fiber, the second single mode fiber, and the third single mode fiber ranges from 1 m to 3000 m.

7. The all fiber, mode locked fiber laser of claim 1, wherein the bandpass filter and dispersion device has a bandwidth ranging from 1 nm to 20 nm.

8. The all fiber, mode locked fiber laser of claim 1, wherein the bandpass filter and dispersion device is the bandpass filter and a volume chirped grating, the bandpass filter and a photonic crystal fiber, the bandpass filter and a photonic bandgap fiber, or a fiber Bragg chirped grating.

9. The all fiber, mode locked fiber laser of claim 1, wherein the Ytterbium doped fiber has a doping concentration ranging from 10,000 ppm to 2,000,000 ppm.

10. The all fiber, mode locked fiber laser of claim 1, wherein the WDM coupler is a 980/1060 coupler or a 980/1030 coupler.

11. The all fiber, mode locked fiber laser of claim 1, wherein the in-line polarization beam splitter is a polarization splitter cube or a birefringence crystal.

12. A method for generating mode locked, femtosecond and picosecond laser pulses, the method comprising:
generating electromagnetic radiation from a pump laser; and
coupling the pump laser electromagnetic radiation to a ring cavity comprising:
a WDM coupler comprising an input and an output, wherein the pump laser is coupled to the input of the WDM coupler;
a Ytterbium doped fiber comprising an input and an output, wherein the input of the Ytterbium doped fiber is coupled to the output of the WDM coupler;
a first single mode fiber comprising an input and an output, wherein the input of the first single mode fiber is coupled to the output of the Ytterbium doped fiber;
a bandpass filter and dispersion device comprising an input and an output, wherein the input of the bandpass filter and dispersion device is coupled to the output of the first single mode fiber;
a second single mode fiber comprising an input and an output, wherein the input of the second single mode fiber is coupled to the output of the bandpass filter and dispersion device;
a first in-line polarization controller comprising an input and an output, wherein the input of the first in-line polarization controller is coupled to the output of the second single mode fiber;
an in-line polarization beam splitter comprising an input, a polarization maintaining output configured to emit the laser pulses out of the ring cavity, and a single mode fiber output, wherein the input of the in-line polarization beam splitter is coupled to the output of the first in-line polarization controller;
a polarization insensitive isolator comprising an input and an output, wherein the input of the polarization insensitive isolator is coupled to the single mode fiber output of the in-line polarization beam splitter;
a second in-line polarization controller comprising an input and an output, wherein the input of the second in-line polarization controller is coupled to the output of the polarization insensitive isolator;
a third single mode fiber comprising an input and an output, wherein the input of the third single mode fiber is coupled to the output of the second in-line polarization controller and the output of the third single mode fiber is coupled to the input of the WDM coupler; and
wherein the ring cavity is configured to operate at net anomalous dispersion.

13. The method of claim 12, wherein the laser pulses have a center lasing wavelength ranging from 1025 nm to 1100 nm.

14. The method of claim 12, wherein the laser pulses have a pulse repetition rate ranging from 50 kHz to 100 MHz.

15. The method of claim 12, wherein the laser pulses have a spectrum bandwidth ranging from 0.5 nm to 30 nm.

16. The method of claim 12, wherein the laser pulses have a chirped pulse width ranging from 100 fs to 3 ns and the chirped output pulses can be de-chirped from 10 fs to 10 ps.

17. The method of claim 12, wherein the total length of the first single mode fiber, the second single mode fiber, and the third single mode fiber ranges from 1 m to 3000 m.

18. The method of claim 12, wherein the bandpass filter and dispersion device has a bandwidth ranging from 1 nm to 20 nm.

19. The method of claim 12, wherein the bandpass filter and dispersion device is the bandpass filter and a volume chirped grating, the bandpass filter and a photonic crystal fiber, the bandpass filter and a photonic bandgap fiber, or a fiber Bragg chirped grating.

20. The method of claim 12, wherein the Ytterbium doped fiber has a doping concentration ranging from 10,000 ppm to 2,000,000 ppm.

21. The method of claim 12, wherein the WDM coupler is a 980/1060 coupler or a 980/1030 coupler.

22. The method of claim 12, wherein the in-line polarization beam splitter is a polarization splitter cube or a birefringence crystal.
